(19) United States
(12) Patent Application Publication
(10) Pub. No.: US 2009/0246430 A1
(43) Pub. Date: Oct. 1, 2009

(54) BIO-BASED POLYETHYLENE TEREPHTHALATE POLYMER AND METHOD OF MAKING SAME

(75) Inventors: Robert M. Kriegel, Decatur, GA (US); Xiaoyan Huang, Marietta, GA (US); Mikell W. Schultheis, Acworth, GA (US)

Correspondence Address: THE COCA-COLA COMPANY;PATENT & TECHNOLOGY DEPT--NAT 19, P. O. BOX 1734, ATLANTA, GA, 30301, US

(73) Assignee: THE COCA-COLA COMPANY, Atlanta, GA (US)

(21) Appl. No.: 12/210,208

(22) Filed: Sep. 14, 2008

Related U.S. Application Data
(60) Provisional application No. 61/040,349, filed on Mar. 28, 2008.

(51) Int. Cl. B32B 1/02; B32B 27/00; C08G 63/183; C08L 33/06

(52) U.S. Cl. 428/36.6; 428/35.7; 528/307; 528/308.1; 523/500

(57) ABSTRACT

A bio-based polyethylene terephthalate polymer comprising from about 25 to about 75 weight percent of a terephthalate component and from about 20 to about 50 weight percent of a diol component, wherein at least about one weight percent of at least one of the terephthalate and/or the diol component is derived from at least one bio-based material. A method of producing a bio-based polyethylene terephthalate polymer comprising obtaining a diol component comprising ethylene glycol, obtaining a terephthalate component comprising terephthalic acid, wherein at least one of the diol component and/or the diol component is derived from at least one bio-based material, and reacting the diol component and the terephthalate component to form a bio-based polyethylene terephthalate polymer comprising from about 25 to about 75 weight percent of the terephthalate component and from about 20 to about 50 weight percent of the diol component.

### RELATED APPLICATION DATA

The present application claims priority under 35 U.S.C. §119(e) to U.S. Provisional Application No. 61/040349, entitled “Bio-based Polyethylene Terephthalate and Articles Made from Bio-based Polyethylene Terephthalate” and filed on Mar. 28, 2008.

### FIELD OF INVENTION

This invention relates generally to a bio-based polyethylene terephthalate polymer that contains a terephthalate and/or a diol component that derives partially or totally from bio-based materials.

### BACKGROUND

Polyethylene terephthalate and its copolyesters (hereinafter referred to collectively as “PET” or “polyethylene terephthalate”) is a widely used raw material for making packaging articles in part due to their excellent combination of clarity, mechanical, and gas barrier properties. Examples of PET products include, but are not limited to, bottles and containers for packaging food products, soft drinks, alcoholic beverages, detergents, cosmetics, pharmaceutical products and edible oils.

Most commercial methods produce PET with petrochemically derived raw materials. Therefore, the cost of production is closely tied to the price of petroleum. Petrochemically-derived PET contributes to greenhouse emissions due to its high petroleum derived carbon content. Furthermore, petrochemicals take hundreds of thousands of years to form naturally, making petrochemically-derived products non-renewable, which means they cannot be re-made, re-grown, or regenerated at a rate comparative to its consumption.

One approach to substituting petrochemically-derived PET has been the production of polylactic acid (PLA) bioplastics from bio-based materials such as corn, rice, or other sugar and starch-producing plants. See e.g. U.S. Pat. No. 6,569,989. As described in U.S. Pat. No. 5,409,751 and U.S. Pat. App. No. 20070187876, attempts have been made to use PLA resins in injection stretch molding processes for producing containers. However, it is often difficult to adapt PLA into current PET production lines or to satisfactorily substitute PET with PLA in many applications due to the significantly different properties between PLA and PET. For example, PLA typically has a lower gas barrier property than PET, which makes PLA containers less suitable for storing items such as carbonated beverages or beverages sensitive to oxygen. Furthermore, most recycling systems currently in use are designed for PET, which would be contaminated if PLA was introduced. This problem could be overcome by costly solutions such as using distinctive bottle types between PLA and PET or by investing in suitable sorting technology or new recycling streams.

Thus, there exists a need for a PET derived from renewable resources that shares similar properties as petroleum-derived PET. It would be also desirable in some applications if the PET derived from renewable resources can be processed through existing PET manufacturing facilities and/or can be readily recycled through the systems designed for recycling petroleum-derived PET.

Other objects, features, and advantages of this invention will be apparent from the following detailed description, drawings, and claims.

### BRIEF DESCRIPTION OF THE DRAWING

FIG. 1 is a flowchart illustration of the method of making a bio-based polyethylene terephthalate product that partially or totally derives from bio-based materials.

### DETAILED DESCRIPTION OF THE PRESENT INVENTION

The term “bio-based,” as used in this application, indicates the inclusion of some component that derives from at least one bio-based material. For example, a “bio-based PET polymer” would be a PET polymer that comprises at least one component that partially or totally derives from at least one bio-based material.

### Bio-Based PET Polymer

One embodiment of the present invention encompasses a bio-based PET polymer that comprises from about 25 to about 75 weight percent of a terephthalate component and from about 20 to about 50 weight percent of a diol component, wherein at least about one weight percent of at least one of the terephthalate component and/or the diol component is derived from at least one bio-based material. In a more particular embodiment, at least about 20 weight percent of at least one of the terephthalate component and/or the diol component is derived from at least one bio-based material.

In one embodiment, the bio-based PET polymer comprises from about 30 to about 70 weight percent of the terephthalate component. In a more particular embodiment, the bio-based PET polymer comprises from about 40 to about 65 weight percent of the terephthalate component. In another embodiment, the bio-based PET polymer comprises from about 25 to about 45 weight percent of the diol component. In a more particular embodiment, the bio-based PET polymer comprises from about 25 to about 35 weight percent of the diol component.

According to a particular embodiment of the invention, the terephthalate component is selected from terephthalic acid, dimethyl terephthalate, isophthalic acid, and a combination thereof. In a more particular embodiment, at least about ten weight percent of the terephthalate component is derived from at least one bio-based material. In one embodiment, the terephthalate component comprises at least about 70 weight percent of terephthalic acid. In a more particular embodiment, at least about one weight percent, preferably at least about ten weight percent, of the terephthalic acid is made from at least one bio-based material.

In another embodiment, the diol component is selected from ethylene glycol, cyclohexane dimethanol, and a combination thereof. In a more particular embodiment, the diol component comprises at least about one weight percent of cyclohexane dimethanol. In another embodiment, at least about ten weight percent of the diol component is derived from at least one bio-based material.

Other ingredients may be added to the bio-based PET polymer. Those of ordinary skill in the art would readily be able to select the suitable ingredient(s) to add to the bio-based PET polymer to improve the desired properties, which may depend on the type of application intended. In a particular embodiment, the bio-based PET polymer may further comprise a supplemental component selected from at least one coloring agent, at least one fast reheat additive, at least one gas barrier additive, at least one UV blocking additive, and a combination thereof.

Bio-based PET polymers may be used to form bio-based resins, which may be further processed into bio-based containers using methods including, but not limited to, injection molding and stretch blow molding. Embodiments of the present invention encompass bio-based containers that comprise the bio-based PET polymers of the above-described embodiments. To be suitable for certain applications, containers have a certain intrinsic viscosity to withstand movements, shelving, and other requirements. In a more particular embodiment of the present invention, the bio-based container has an intrinsic viscosity from about 0.45 dL/g to about 1.0 dL/g.

It is known in the art that carbon-14 (C-14), which has a half life of about 5,700 years, is found in bio-based materials but not in fossil fuels. Thus, “bio-based materials” refer to organic materials in which the carbon comes from non-fossil biological sources. Examples of bio-based materials include, but are not limited to, sugars, starches, corns, natural fibers, sugarcanes, beets, citrus fruits, woody plants, cellulosics, lignocelluosics, hemicelluloses, potatoes, plant oils, other polysaccharides such as pectin, chitin, levan, and pullulan, and a combination thereof. According to a particular embodiment, the at least one bio-based material is selected from corn, sugarcane, beet, potato, starch, citrus fruit, woody plant, cellulosic lignin, plant oil, natural fiber, oily wood feedstock, and a combination thereof.

As explained previously, the detection of C-14 is indicative of a bio-based material. C-14 levels can be determined by measuring its decay process (disintegrations per minute per gram carbon or dpm/gC) through liquid scintillation counting. In one embodiment of the present invention, the bio-based PET polymer comprises at least about 0.1 dpm/gC (disintegrations per minute per gram carbon) of C-14.

The invention is further illustrated by the following example, which is not to be construed in any way as imposing limitations on the scope thereof. On the contrary, it is to be clearly understood that resort may be had to various other embodiments, modifications, and equivalents thereof which, after reading the description herein, may suggestion themselves to those skilled in the art without departing from the spirit of the present invention and/or scope of the appended claims.

### EXAMPLE I

The following samples were measured, in a blind test fashion, to determine the presence of C-14 content by liquid scintillation counting. The levels detected were normalized to existing data available at University of Georgia that correlates the C-14 level to the bio-based percentage. The results are shown in Table 1.

TABLE 1

| Sample | | C-14 | % bio-based |
|---|---|---|---|
| ID | Sample Description | (dpm/gC) | material |
| 1 | Ethylene glycol (totally derived from ethanol | 15 ± 0.13 | 100 ± 1 |
| | converted from sugars) | | |
| 2 | Ethylene glycol (totally derived from corn) | 15 ± 0.13 | 98 ± 1 |
| 3 | Ethylene glycol (totally derived from petroleum) | 0.04 ± 0.13 | 0 ± 1 |
| 4 | Ethylene glycol (totally derived from petroleum) | 0.04 ± 0.13 | 0 ± 1 |
| 5 | PET (totally derived from petroleum) | 0.07 ± 0.13 | 0 ± 1 |
| 6 | PET (contains about 30 wt % of ethylene glycol | 3.01 ± 0.13 | 21 ± 1 |
| | from sample 1 and about 70 wt % of terephthalic | | |
| | acid derived from petroleum) | | |

As shown in Table 1, samples totally derived from petroleum (samples 2, 3, and 4) contain a negligible amount of C-14, indicating that about zero percent of the sample is made from bio-based materials. In contrast, samples that contain materials known to be partially or totally derived from a bio-based material (corn or sugar) show a much higher level of C-14. Based on the data, about 0.14 dpm/gC corresponds to about one percent of bio-based material in the sample.

### Method of Making Polyethylene Terephthalate Polymer

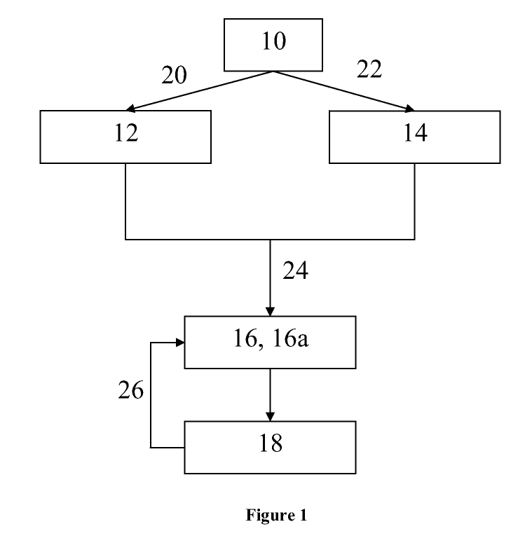

Referring to FIG. 1, embodiments of the present invention also encompass a process for producing a bio-based PET polymer 16 comprising obtaining a diol component 12 comprising ethylene glycol 12a [step 20], obtaining a terephthalate component 14 comprising terephthalic acid [step 22], wherein at least about one weight percent of one of the diol component and/or the terephthalate component (12, 14) is derived from at least one bio-based material 10, reacting the diol component 12 and the terephthalate component 14 to form a bio-based PET polymer 16 [step 24], wherein the bio-based PET polymer 16 comprises from about 25 to about 75 weight percent of the terephthalate component 14 and from about 20 to about 50 weight percent of the diol component 12. In a more particular embodiment, as illustrated in Reaction I, step 24 further comprises reacting the diol component 12 and the terephthalate component 14 through an esterification reaction to form bio-based PET monomers 16a, which then undergo polymerization to form the bio-based PET polymer 16.

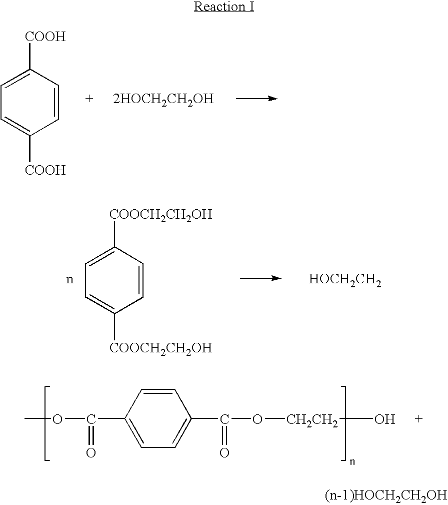

In a particular embodiment, at least about one weight percent of the diol component 12 is derived from at least one bio-based material 10. In a more particular embodiment, at least ten weight percent of the diol component 12 is derived from at least one bio-based material 10. In still a more particular embodiment, at least 30 weight percent of the diol component 12 is derived from at least one bio-based material 10.

The diol component 12 may be partially or totally derived from at least one bio-based material using any process. In one embodiment, step 20 comprises obtaining a sugar or derivatives thereof from at least one bio-based material and fermenting the sugar or derivatives thereof to ethanol. In another embodiment, step 20 comprises gasification of at least one bio-based material 10 to produce syngas, which is converted to ethanol. In a more particular embodiment, as illustrated by Reaction II, step 20 further comprises dehydrating ethanol to ethylene, oxidizing ethylene to ethylene oxide, and converting ethylene oxide to ethylene glycol.

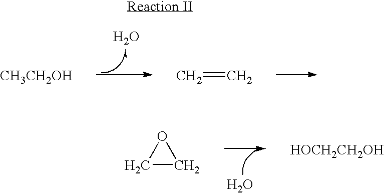

In another embodiment, step 20 comprises obtaining a sugar or derivatives thereof from at least one bio-based material and converting the sugar or derivatives thereof to a mixture comprising ethylene glycol and at least one glycol excluding the ethylene glycol. Step 20 further comprises isolating the ethylene glycol from the mixture. The mixture may be repeatedly reacted to obtain higher yields of ethylene glycol. In a more particular embodiment, the at least one glycol is selected from butanediols, propandiols, and glycerols.

According to another embodiment, at least about one weight percent of the terephthalate component 14 is derived from at least one bio-based material 10. In a more particular embodiment, at least ten weight percent of the terephthalate component 14 is derived from at least one bio-based material 10. In still a more particular embodiment, at least 30 weight percent of the terephthalate component 14 is derived from at least one bio-based material 10.

The terephthalate component 14 may be partially or totally derived from at least one bio-based material using any process. In one embodiment, as illustrated in Reaction III, step 22 comprises extracting carene from an oily wood feedstock, converting the carene to p-cymene and m-cymene by dehyodrgenation and aromatization, and oxidizing p-cymene and m-cymene to terephthalic acid and isophthalic acid.

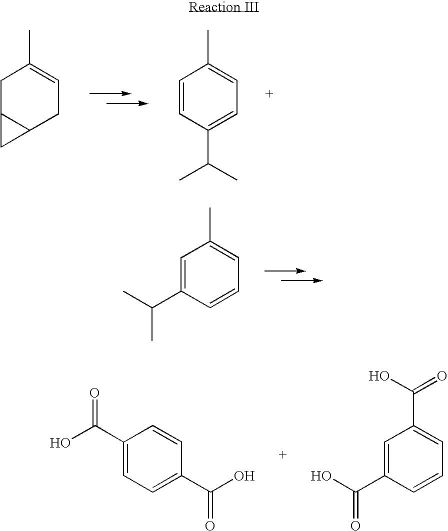

In another embodiment, as illustrated in Reaction IV, step 22 comprises extracting limonene from at least one bio-based material, converting the limonene to at least one terpene, converting the terpene to p-cymene and oxiding the p-cymene to terephthalic acid. In a more particular embodiment, the at least one terpene is selected from terpinene, dipentene, terpinolene, and combinations thereof. In still a more particular embodiment, the at least one bio-based material is selected from a citrus fruit, a woody plant, or a combination thereof.

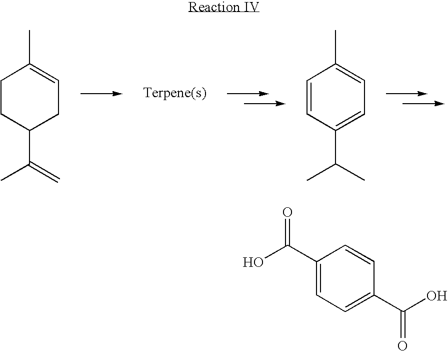

In one embodiment of the present invention, as described in Reaction V, step 22 comprises extracting hydroxymethylfurfural from a bio-based material, converting hydroxymethylfurfural to a first intermediate, reacting the first intermediate with ethylene to form a second intermediate, treating the second intermediate with an acid in the presence of a catalyst to form hydroxymethyl benzaldehyde, and oxidizing hydroxymethyl benzaldehyde to terephthalic acid. In a more particular embodiment, the hydroxymethylfurfural is extracted from a bio-based material selected from corn syrup, sugars, cellulose, and a combination thereof. In still a more particular embodiment, the ethylene is derived from at least one bio-based material.

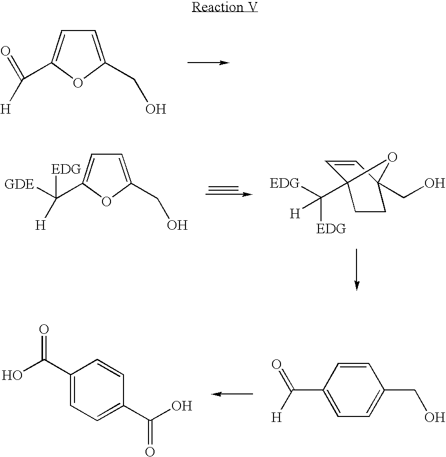

In another embodiment, step 22 comprises gasification of at least one bio-based material 10 to produce syngas, converting syngas p-xylene, and oxidizing p-xylene in acid to form terephthalic acid.

In one embodiment, at least about one weight percent of the terephthalate component 14 is derived from at least one bio-based material 10 and at least about one weight percent of the diol component 12 is derived from at least one bio-based material 10. In a more particular embodiment, at least about 25 weight percent of the terephthalate component 14 is derived from at least one bio-based material 10. In still a more particular embodiment, at least about 70 weight percent of the diol component 12 is derived from at least one bio-based material 10. According to a particular embodiment, the bio-based material is selected from corn, sugarcane, beet, potato, starch, citrus fruit, woody plant, cellulosic lignin, plant oil, natural fiber, oily wood feedstock, and a combination thereof.

In another embodiment, the method further comprises making a bio-based PET product 18 from the bio-based PET polymer 16. The bio-based PET product 18 may be used in various applications, including, but not limited to, as a beverage container. In another embodiment, the bio-based PET product 18 may be recycled or reused through recycling systems [step 26] designed for petroleum-derived PET products.

It should be understood that the foregoing relates to particular embodiments of the present invention, and that numerous changes may be made therein without departing from the scope of the invention as defined from the following claims.

1. A bio-based polyethylene terephthalate polymer comprising
from about 25 to about 75 weight percent of a terephthalate component, wherein the terephthalate component is selected from terephthalic acid, dimethyl terephthalate, isophthalic acid, and a combination thereof, and
from about 20 to about 50 weight percent of a diol component, wherein the diol component is selected from ethylene glycol, cyclohexane dimethanol, and a combination thereof,
wherein at least about one weight percent of at least one of the terephthalate and/or the diol component is derived from at least one bio-based material.

2. The bio-based polyethylene terephthalate polymer of claim 1, wherein at least about ten weight percent of the diol component is derived from at least one bio-based material.

3. The bio-based polyethylene terephthalate polymer of claim 1, wherein at least about ten weight percent of the terephthalate component is derived from at least one bio-based material.

4. The bio-based polyethylene terephthalate polymer of claim 1, wherein the terephthalate component comprises at least about 70 weight percent of terephthalic acid and wherein at least about ten weight percent of the terephthalic acid is derived from at least one bio-based material.

5. The bio-based polyethylene terephthalate polymer of claim 1, wherein the at least one bio-based material is selected from corn, sugarcane, beet, potato, starch, citrus fruit, woody plant, cellulosic lignin, plant oil, natural fiber, oily wood feedstock, and a combination thereof.

6. The bio-based polyethylene terephthalate polymer of claim 1, wherein the diol component comprises at least about one weight percent of cyclohexane dimethanol.

7. The bio-based polyethylene terephthalate polymer of claim 1, further comprising a supplemental component selected from at least one coloring agent, at least one fast reheat resistant additive, at least one gas barrier additive, at least one UV blocking additive, and a combination thereof.

8. A bio-based container comprising the bio-based polyethylene terephthalate polymer of claim 1.

9. The bio-based container of claim 8, wherein the bio-based polyethylene terephthalate polymer comprises at least about 0.1 dpm/gC of carbon-14.

10. The container of claim 8, wherein the bio-based container has an intrinsic viscosity from about 0.45 dL/g to about 1.0 dL/g.

11. A bio-based container comprising a bio-based polyethylene terephthalate polymer, wherein at least one weight percent of the polyethylene terephthalate polymer is derived from at least one bio-based material, wherein the bio-based container has an intrinsic viscosity from about 0.45 dL/g to about 1.0 dL/g.

12. The bio-based container of claim 11, wherein the bio-based polyethylene terephthalate polymer comprises from about 25 to about 75 weight percent of a terephthalate component, wherein the terephthalate component is selected from terephthalic acid, dimethyl terephthalate, isophthalic acid, and a combination thereof, and
from about 20 to about 50 weight percent of a diol component, wherein the diol component is selected from ethylene glycol, cyclohexane dimethanol, and a combination thereof;
wherein at least about ten weight percent of the diol component is derived from at least one bio-based material.

13. The bio-based container of claim 12, wherein at least about ten weight percent of the terephthalate component is derived from at least one bio-based material.

14. The bio-based container of claim 12, wherein the terephthalate component comprises at least about 70 weight percent of terephthalic acid and wherein at least about ten weight percent of the terephthalic acid is derived from at least one bio-based material.

15. The bio-based container of claim 11, wherein the at least one bio-based material is selected from corn, sugarcane, beet, potato, starch, citrus fruit, woody plant, cellulosic lignin, plant oil, natural fiber, oily wood feedstock, and a combination thereof.

16. The bio-based container of claim 11, wherein the bio-based polyethylene terephthalate polymer further comprises a supplemental component selected from at least one coloring agent, at least one fast reheat resistant additive, at least one gas barrier additive, at least one UV blocking additive, and a combination thereof.

17. The bio-based container of claim 11, wherein the bio-based container comprises at least about 0.1 dpm/gC of carbon-14.

18. A method of producing a bio-based polyethylene terephthalate polymer comprising
a. obtaining a diol component comprising ethylene glycol;
b. obtaining a terephthalate component comprising terephthalic acid,
wherein at least one of the diol and/or the terephthalate component is derived from at least one bio-based material; and
c. reacting the diol component and the terephthalate component to form a bio-based polyethylene terephthalate polymer, wherein the bio-based polyethylene terephthalate polymer comprises from about 25 to about 75 weight percent of the terephthalate component and from about 20 to about 50 weight percent of the diol component.

19. The method of claim 18, further comprising forming a bio-based polyethylene terephthalate resin from the bio-based polyethylene terephthalate polymer, wherein the bio-based polyethylene terephthalate resin comprises at least about 0.1 dpm/gC of carbon-14.

20. The method of claim 18, wherein at least about ten weight percent of the ethylene glycol is derived from at least one bio-based material.

21. The method of claim 18, wherein at least about ten weight percent of the terephthalic acid is derived from at least one bio-based material.

22. The method of claim 18, wherein the at least one bio-based material is selected from corn, sugarcane, beet, potato, starch, citrus fruit, woody plant, cellulosic lignin, oily wood feedstock, and a combination thereof.

23. The method of claim 18, wherein step (a) further comprises
i. obtaining sugar or derivatives thereof from at least one bio-based material;
ii. fermenting sugar or derivatives thereof to ethanol;
iii. dehydrating ethanol to ethylene;
iv. oxidizing ethylene to ethylene oxide; and
v. converting ethylene oxide to ethylene glycol.

24. The method of claim 18, wherein step (a) further comprises
i. obtaining sugar or derivatives thereof from at least one bio-based material;
ii. reacting sugar or derivatives to form a mixture comprising ethylene glycol and at least one glycol excluding the ethylene glycol; and
iii. separating ethylene glycol from the mixture.

25. The method of claim 18, wherein step (b) further comprises
i. obtaining carene from at least one bio-based material;
ii. converting carene to cymene; and
iii. oxidizing cymene to terephthalic acid.

26. The method of claim 18, wherein step (b) further comprises
i. obtaining limonene from at least one bio-based material;
ii. converting the limonene to at least one terpene;
iii. converting the at least one terpene to cymene; and
iv. oxidizing cymene to terephthalic acid.

27. The method of claim 18, further comprising adding a supplemental component to the bio-based polyethylene terephthalate polymer, wherein the supplement component is selected from at least one coloring agent, at least one fast reheat additive, at least one gas barrier additive, at least one UV blocking additive, and a combination thereof.

28. The bio-based polyethylene terephthalate polymer produced by the method of claim 18.

29. A container comprising the bio-based polyethylene terephthalate polymer of claim 26.
